(19) United States
(12) Patent Application Publication
(10) Pub. No.: US 2026/0284930 A1
(43) Pub. Date: Sep. 24, 2026

(54) IN-LINE CARBONATION AND 3D-PRINTING OF CALCIUM SILICATE-BASED CEMENT PASTE WITH CELLULAR ARCHITECTURE

(71) Applicant: The Trustees of Princeton University, Princeton, NJ (US)

(72) Inventors: Nadia RALSTON, Oakland, CA (US); Reza MOINI, Princeton, NJ (US); William MAKINEN, Alexandria, VA (US); Shashank GUPTA, Princeton, NJ (US)

(73) Assignee: The Trustees of Princeton University, Princeton, NJ (US)

(21) Appl. No.: 19/478,066

(22) PCT Filed: Apr. 24, 2024
(86) PCT No.: PCT/US2024/025935

§ 371 Date: Oct. 23, 2025

Related U.S. Application Data
(60) Provisional application No. 63/461,483, filed on Apr. 24, 2023.

(51) Int. Cl. B28B 1/00; B28B 11/24; B28B 13/02; B33Y 10/00; B33Y 30/00; B33Y 50/02; B33Y 70/10; C04B 28/18; C04B 111/00

(52) U.S. Cl. CPC B28B 1/001; B28B 11/245; B28B 13/02; B33Y 10/00; B33Y 30/00; B33Y 50/02; B33Y 70/10; C04B 28/188; C04B 2111/00019; C04B 2111/00068; C04B 2111/00181

(57) ABSTRACT

System and techniques for in-situ carbonation in a 3D printing process may be provided. The system may include a nozzle for in-situ carbonation in a 3D printing process (e.g., of a cement). The layer-3D-printing process with induced interfaces may include a device that enables layer-wise fabrication and enhanced carbonation. Additionally, the techniques may include a design of materials architecture (arrangement) by slicing them in cellular fashion that also enhances carbonation. Further, a printable wollastonite-based paste is disclosed.

### CROSS-REFERENCE TO RELATED APPLICATIONS

The present application claims priority to U.S. Provisional Patent Application No. 63/461,483, filed Apr. 24, 2023, the contents of which are incorporated by reference herein in its entirety.

### TECHNICAL FIELD

The present disclosure is drawn to 3-D printing of cement paste, and specifically to techniques for printing wollastonite-based cement and diffusing CO₂ gas to enhance carbonation in situ.

### BACKGROUND

Non-hydraulic calcium silicate-based cement (CSC) is a promising alternative binder that relies on carbonation, a process in which the material sequesters CO₂ from the atmosphere to harden. The cured calcium silicate cement (CSC) is produced from the same materials as ordinary Portland cement (OPC), but with less limestone and at a kiln temperature that is 250° C. lower than what is required for OPC. By reducing the fossil-fuel-intensive combustion, the CSC cement concrete production process can significantly reduce CO₂, due to both the clinker production and sequestration. To date, these materials have only been cast, as a 3D printing process for such materials has not been developed.

### BRIEF SUMMARY

In various aspects, a print head may be provided. The print head may include a print head body and a plurality of gas outlet nozzles (such as 3-5 gas outlet nozzles). The print head body may define a central lumen extending from a first end to a second end of the print head body along a central axis. The first end may define a first inlet for receiving a 3D printable material (such as a cement, such as a wollastonite-based cement). The second end may define a first outlet for distributing the 3D printable material. Each gas outlet nozzle may be distributed around the first outlet. Each gas outlet may be configured to direct a gas (such as carbon dioxide, CO₂) away from the second end of the print head body and reach any output 3D printable material (e.g., that has been deposited on a surface). Each gas outlet nozzle may be operably coupled to an internal distribution cavity defined by the print head body. The internal distribution cavity may be disposed around the central lumen. The print head body may further define a gas inlet coupled to the internal distribution cavity. The gas inlet may be configured to be operably coupled to a source of a gas.

Each gas outlet nozzle may be spaced an equal distance from an adjacent gas outlet nozzle. Each gas outlet nozzle may have a gas outlet nozzle central axis that is substantially parallel to the central axis of the print head body. At least one gas outlet nozzle may have a central axis that is angled relative to the central axis of the print head body.

In various aspects, a system may be provided. The system may include a print head as disclosed herein. The system may include a gas source of a gas, and a tube coupling the gas source to the gas inlet of the print head. The system may include a valve between the gas source and the print head. The system may include a printing plate disposed at a distance from the second end of the print head body, configured to receive material output from the print head. The system may include a housing or cover around at least the print head and the printing plate, configured to prevent at least some gas output by a gas outlet nozzle of the print head from escaping a volume of space within the housing or cover.

In various aspects, a method for in situ carbonation may be provided. The method may include forming a deposited 3D printed material by depositing a 3D printable material while carbon dioxide gas is diffused onto the deposited 3D printed material.

In various aspects, a method for layer-3D printing with induced interfaces may be provided. The method may include depositing a 3D printable material with a first porosity in the presence of carbon dioxide. The method may include depositing the 3D printable material with a second porosity in the presence of carbon dioxide, the second porosity being greater than the first porosity. The method may include allowing the carbon dioxide to diffuse into the 3D printable material, wherein the 3D printable material with the second porosity will have an increased degree of carbonation.

In various aspects, a method for designing 3D objects may be provided. The method may include receiving information representative of a 3D object. The method may include forming a plurality of slices of the 3D object in a cellular fashion, each slice determined based on one or more parameters, the plurality of slices determined to enhance carbonation of at least a portion of the 3D object. The method may include outputting a path for a 3D printer (e.g., that includes a printer head as disclosed herein) based on the plurality of slices in a predetermined format.

In various aspects, a composition of matter may be provided. The composition may include wollastonite; water in an amount of at least about 40% by weight of the composition; a superplasticizer (such as a polycarbonate ether (PCE) admixture) in an amount of up to about 0.25% by weight of the composition; and a viscosity-modifying admixture (VMA) in an amount of up to about 0.14% by weight of the composition.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is an illustration of a print head.

FIGS. 2 and 3 are a cross-sectional side views of different print heads.

FIG. 4 is a cross-section top view of an example print head.

FIG. 5 is a schematic of a system.

FIG. 6 is a graph showing the normalized degree of carbonation for a cast wollastonite sample under similar conditions as used in Example 2.

FIG. 7 is a boxplot for the modulus of rupture of the samples per specimen design type calculated from the three point bending test.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The design of the construction materials has remained limited to monolithic solids, prohibiting lightweight but strong structures. Strength remains a limitation in bulk carbonatable binders and is a barrier to the adoption and scaling up of these materials. Yet, the approach disclosed herein highlights the opportunistic approach to utilizing additive manufacturing for bettering materials properties by design through cellular schemes.

The disclosed in-situ carbonation during the additive manufacturing approach will enhance the degree of carbonation, mechanical strength, and reduce the strength-related barrier to adopting larger and thicker elements. This is possible by taking advantage of porous interfaces induced by the layer-wise fabrication process, the in-situ carbonation, and the design of cellular materials.

The cement industry today faces several challenges today specific to reducing its CO₂ emissions include the heavy dependence on high carbon fossil fuels and limestone-based clinker. The CO₂ generation during the fossil-fuel intensive combustion and decarbonation of the limestone during the calcination process accounts for up to 90% of the cement's greenhouse gas emissions. The raw materials for cement are combined in a kiln that is heated up to 1450° C. through a process that requires significant energy input to reach such high temperatures. During the hydration process, the active ingredients of the cement powder react with water to form stable calcium silicate hydrates as the binding material in concrete when it hardens.

A promising alternative to OPC (and the standard OPC manufacturing process) is to utilize calcium silicate cement (CSC). Although concrete carbonates as well, the difference is that CSC hardens through carbonation as it sequester concentrated CO₂ not hydration. In other words, the low-lime binder reduces act like a carbon sink and in contrast to OPC, the carbonation process of CSC binders can save up to 50-70% in CO₂, or 500 kg CO₂ per ton of cement. At the same time, CO₂ cured calcium silicate cement (CSC) is produced from the same materials as ordinary Portland cement (OPC), but with less limestone and at a kiln temperature that is 250° C. lower than what is required for OPC. Nonetheless, explorations continue into various developing techniques as several aspects of this carbonation activated binder require further investigations into the long-term durability properties to analyze its suitability in the concrete industry.

In addition to compositional changes in the cement, another avenue of innovation in sustainable concrete design explores the incorporation of additive manufacturing, also colloquially known as 3-D concrete printing. 3D printing concrete technology is an emerging field of study that can optimize the structural elements of a cementitious design. This eco-friendly alternative to traditional manufacturing process limits waste generated and is less time consuming since additive manufacturing can be up to 20 times faster. The potential of on-site printing through such advancements in the construction industry is critical for developmental initiatives such as low-cost quick-build housing projects globally. Additionally, the design of materials architecture has been explored as a means to improve the inherent mechanical properties of additive manufactured concrete. However, there is no prior work that explores the printing of specific CSC binders which provides a novel route to pursue sustainable concrete design at the intersection of CO₂ sequestration through low-lime binders and 3D printing technology.

The opportunistic utilization of fabrication flexibility from additive processes relies on harnessing designs of materials and topologies that are otherwise cumbersome, inefficient, or difficult to achieve. This can help generate improved possibilities in construction materials beyond mechanical functions. There is no prior work known in the literature that explores the printing of low-lime binders (e.g., wollastonite, pseudo-wollastonite) or other binders that solidify via carbonation which provides a route to pursue sustainable concrete design by enabling enhanced CO₂ sequestration (compared to monolithic cast counterparts) through 3D printing technology.

Disclosed herein is in-line carbonation and 3D-printing of calcium silicate-based cement paste with cellular architecture. The disclosed approach comprises a supplementary device to a 3D printer that will carry an additive process capable of printing wollastonite-based cement and diffuse CO2 gas to enhance carbonation in-situ (in-line with printing process).

An important aspect of the disclosed approach is to enhance the exposure of CO2 throughout the printing process for the wollastonite-based cement via the 3D-printing process to augment early strength development in the material.

Uses for the techniques include small-scale and/or scalable development of low-carbon concrete materials with higher thickness for monolithic and architected components (slabs, pavement blocks, etc.), and pre-fabrication processes of more robust and larger infrastructure components for buildings and the transportation sector. All of the disclosed components could be manufactured at smaller (desktop-scale) components or scaled up for larger (building-scaled) architectural features.

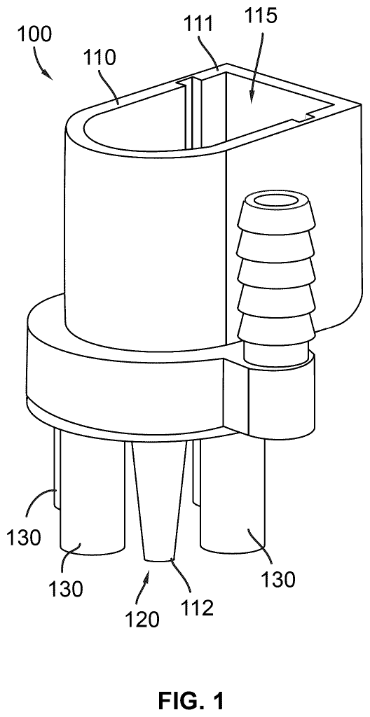

In various aspects, a print head may be provided. Referring to FIGS. 1-3, the print head (100) may include a print head body (110) and a plurality of gas outlet nozzles (120).

The print head body may define a central lumen (115) (which may sometimes be referred to as an opening, port, channel, etc.) that extends from a first end (111) to a second end (112) of the print head body along a central axis (210).

The first end (111) may define a first inlet for receiving a 3D printable material (such as a cement, such as a wollastonite-based cement). The second end may define a first outlet (120) for distributing the 3D printable material.

Any number of gas outlet nozzles is envisioned. There may be at least 3 gas outlet nozzles. There may be at least 4 gas outlet nozzles. There may be no more than 4 gas outlet nozzles. There may be no more than 5 gas outlet nozzles. There may be no more than 6 gas outlet nozzles.

Each gas outlet nozzle (130) may have one or more walls (220) defining an internal lumen (221) (which may sometimes be referred to as an opening, port, channel, etc.) that extends from a first end (222) to a second end (223). The first end (222) may be coupled (including removably coupled) to the print head body (110).

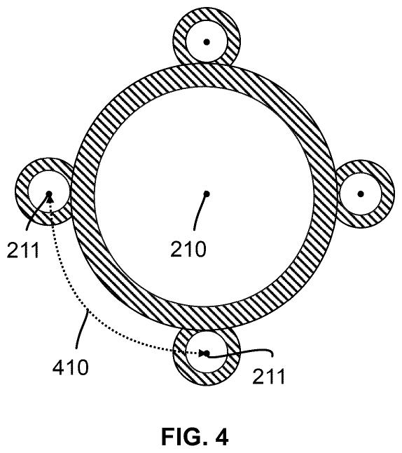

Each gas outlet nozzle (130) may be distributed around the first outlet (120). Referring briefly to FIG. 4, in some embodiments, each gas outlet nozzle may be spaced an equal distance (e.g., a circumferential distance (410)) around the central axis of the print head body, between the central axes (e.g., central axis (211)) of adjacent gas outlet nozzles. As will be understood, in some embodiments, the spacing may not be equidistant. That is, in some embodiments, at least one gas outlet nozzle may be spaced a different circumferential distance (410) from an adjacent gas outlet nozzle than at least one other gas outlet nozzle.

Each gas outlet may be configured to direct a gas (such as carbon dioxide, CO₂) away from the second end of the print head body and reach any output 3D printable material (e.g., that has been deposited on a surface).

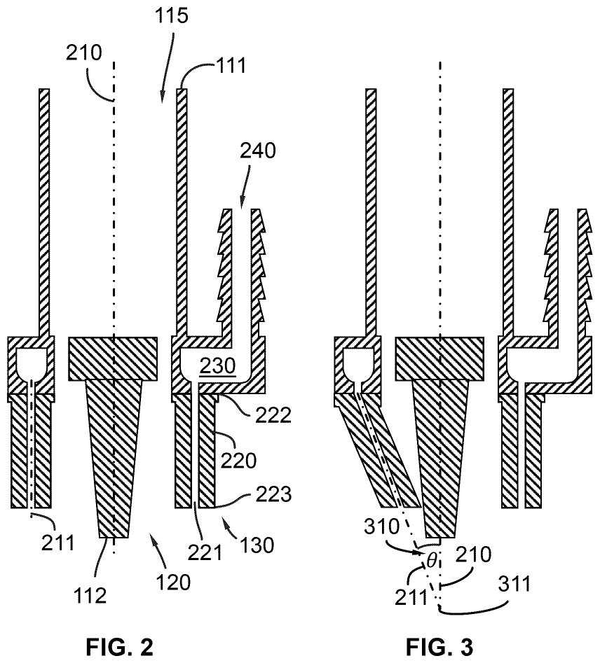

As shown in FIG. 2, each gas outlet nozzle may have a gas outlet nozzle central axis (211) that is substantially parallel to the central axis (210) of the print head body. As used herein, “substantially parallel” refers to the orientation of two elements (e.g., central axes), wherein a deviation of a few degrees, e.g., up to 1 degree, or even up to 2 degrees, from an exact parallel orientation is still considered as “substantially parallel”.

As shown in FIG. 3, in some embodiments, at least one gas outlet nozzle may have a central axis (211) that is angled relative to the central axis (210) of the print head body. That is, in some embodiments, an angle (310) (θ) may be formed between the central axis (211) of a gas outlet nozzle and the central axis (210) of the print head body. In some embodiments, the angle (310) (θ) may be no more than 45 degrees. In some embodiments, the angle (310) (θ) may be no more than 30 degrees. In some embodiments, the angle (310) (θ) may be no more than 15 degrees. In some embodiments, the angle (310) (θ) may be at least 5 degrees. In some embodiments, the vertex (311) of the angle (310) may be downstream from the second end (112) of the print head body (e.g., the gas outlet nozzle may be angled towards the first outlet (120)). In some embodiments, the vertex (311) of the angle (310) may be upstream from the second end (112) of the print head body (e.g., the gas outlet nozzle may be angled away from the first outlet (120)).

Each gas outlet nozzle may be operably coupled to an internal distribution cavity (230) defined by the print head body. The internal distribution cavity may be disposed around the central lumen (115)

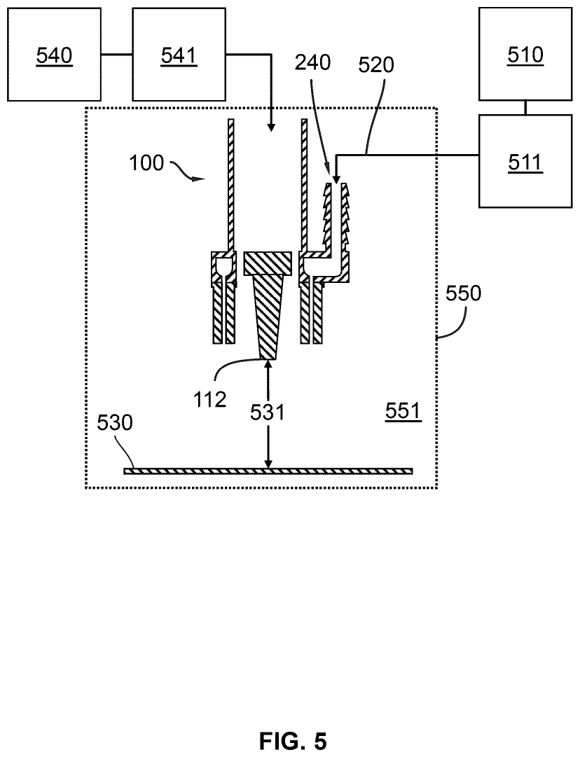

The print head body may further define a gas inlet (240) that is coupled to the internal distribution cavity. The gas inlet may be configured to be operably coupled to a source of a gas (see, e.g., FIG. 5).

In various aspects, a system may be provided. Referring to FIG. 5, the system may include a print head (100) as disclosed herein. The system may include a gas source (510) of a gas. The gas may be, e.g., carbon dioxide (CO₂). The gas may be a mixture of gasses including carbon dioxide. The system may include a tube (520) coupling the gas source (510) to the gas inlet (240) of the print head. The system may include a valve (511) between the gas source and the print head.

Adjustments to the flow rate/pressure of the CO₂ gas, is currently limited to the control valves on the CO₂ tank rather than on the nozzle or tube to allow for automatic adjustments. This can be overcome by use of an in-hose valve (e.g., valve (511)).

The system may include a material source (540) of a 3D printable material operably coupled to the print head. The system may include a pump (541) configured to control the flow the 3D printable material to the print head.

The system may include a printing plate (530) disposed at a distance (531) (e.g., a distance>0) from the second end (112) of the print head body. The printing plate may be configured to receive material output from the print head.

The system may include a housing (550) or cover disposed at least partially around at least the print head and the printing plate, configured to prevent at least some gas output by a gas outlet nozzle of the print head from escaping a volume of space (551) within the housing or cover. If it is needed to increase the amount of diffused CO₂ onto the print, the appropriate encapsulation and recycling/ventilating of the CO₂ with respect to the printed object or the entire printer is needed. This is to reduce the effects of high CO₂ exposure but also to not waste/generate CO₂ in the carbonation process. This will become more important as the process scales up.

### Example 1

A 3D print head was made of PLA and consists of four equidistant nozzles located in each cardinal direction with an aperture in the center for the extrusion nozzle to protrude through. For this attachment, a polyethylene tube with an internal diameter of 9.23 mm connected from the Airgas CO₂ in a Size 40 High-Pressure Steel Cylinder tank to the 3D printed attachment as disclosed herein (see, e.g., FIGS. 1 and 5). The CO₂ gas was distributed through the four nozzles so that the diffused gas can reach the recently deposited material irrespective of printing direction. Special consideration was made to the respective heights of the attachment nozzle height and the extrusion nozzle so that space was allowed between the diffused CO₂ and the deposited layer to avoid any printing errors. In-situ carbonation process: In-situ CO₂ circulation during the 3D printing process takes advantage of discretized characteristics of the additive process to favor carbonation and early strength development. When the printing is initiated, the material will be deposited through the extrusion nozzle while CO₂ gas is diffused onto the deposited material. Thus, the in-situ carbonation printing process enables a higher degree of carbonation and significantly higher strength compared to the monolithic cast counterparts.

In various aspects, a method for in situ carbonation may be provided. The method may include forming a deposited 3D printed material by depositing a 3D printable material (e.g., using a printer head as disclosed herein) while a gas that includes carbon dioxide is directed out of gas outlet nozzles and diffused onto the deposited 3D printed material. The 3D printable material may be a wollastonite-based paste as disclosed herein.

In various aspects, a method for layer-3D printing with induced interfaces may be provided. The method may include depositing a 3D printable material with a first porosity in the presence of carbon dioxide. The method may include depositing the 3D printable material with a second porosity in the presence of carbon dioxide, the second porosity being greater than the first porosity. The method may include allowing the carbon dioxide to diffuse into the 3D printable material, wherein the 3D printable material with the second porosity will have an increased degree of carbonation.

The creation of materials and structures with 3D-printing in a layer-wise fashion leads to the presence of interfaces. These interfaces can be more porous and thus can enhance post-carbonation printing. Thus, the printing process enables a higher degree of carbonation and significantly higher strength compared to the monolithic cast counterparts. In addition, the inherent layered porosity from the 3D-printing process promotes the carbonation within the volume as interconnected carbonation network.

In various aspects, a method for designing 3D objects may be provided. The method may include receiving information representative of a 3D object. The method may include forming a plurality of slices of the 3D object in a cellular fashion, each slice determined based on one or more parameters, the plurality of slices determined to enhance carbonation of at least a portion of the 3D object.

As used herein, the term “cellular” printing refers to printing wherein the printed structure defines a plurality of internal cells. In certain embodiments of the disclosed systems and methods, the cellular print may have or be formed using 10%-90% infill. In certain embodiments of the disclosed systems and methods, the cellular print may have or be formed using 20%-80% infill. In certain embodiments of the disclosed systems and methods, the cellular print may have or be formed using 30%-70% infill. In certain embodiments of the disclosed systems and methods, the cellular print may have or be formed using 40%-60% infill. All ranges are inclusive of the endpoints.

The method may include outputting a path for a 3D printer (e.g., that includes a printer head as disclosed herein) based on the plurality of slices in a predetermined format.

In various aspects, a composition of matter may be provided which may be a 3D printable wollastonite-based paste. The composition may include wollastonite. The composition may include water in an amount of at least about 40% by weight of the composition. In some embodiments, the water may be present in an amount of no more than about 60% by weight of the composition. As used herein, the term “about” generally refers to values that could reasonably be rounded up or down to the associated value. For example, “about 10%” would include 9.5-10.5%, inclusive of the endpoints, while “about 0.1% would include 0.05%-0.15%”, inclusive of the endpoints.

The composition may include a superplasticizer (such as a polycarbonate ether (PCE) admixture) in an amount of up to about 0.25% by weight of the composition. In some embodiments, the concentration of superplasticizer (c_{superplastizer}) is 0<c_{superplastizer}≤0.25% by weight of the composition. In some embodiments, 0.1%≤c_{superplastizer}≤0.25% by weight of the composition.

Superplasticizers are well known in the art, and any appropriate superplasticizer may be utilized. As used herein, the term “superplasticizer” generally refers to a type of chemical admixture used where a well-dispersed particle suspension is required. These polymers may be used, e.g., as dispersants to avoid particle segregation and to improve the flow characteristics of suspensions such as in concrete applications. As used herein, the term “plasticizer” or “dispersant” generally refers to an additive that increases the plasticity or fluidity of a material. Plasticizers may be used to, e.g., increase the workability of “fresh” concrete. Non-limiting examples of superplasticizers include, e.g., a polycarboxylate, such as for example a polycarboxylate derivative with polyethylene oxide side chains. In some embodiments, the superplasticizer may be a polycarboxylate ether (PCE) superplasticizer, such as commercially-available GLENIUM® superplasticizers. Polycarboxylate ether-based superplasticizers may be composed of a methoxy-polyethylene glycol copolymer (side chain) grafted with methacrylic acid copolymer (main chain). Other non-limiting examples of superplasticizers include alkyl citrates; sulfur-containing superplasticizers such as sulfonated naphthalene, polynaphthalene sulfonates, sulfonated alene, sulfonated melamine, lignosulfonates, calcium lignosulfonate, naphthalene lignosulfonate, polymelamine sulfonates, and sulfonated melamine formaldehyde condensate; acetone formaldehyde condensate, polycarbonates, or other polycarboxylates. In some embodiments, only a single superplasticizer is utilized. In some embodiments, a combination of two or more superplasticizers may be utilized.

The composition may include a viscosity-modifying admixture (VMA) in an amount of up to about 0.14% by weight of the composition. VMAs are well known in the art, and any appropriate VMA may be utilized. VMAs may include one or more compounds, chosen from a wide range of different chemistries. Non-limiting examples of VMAs include those based on fine inorganic materials like colloidal silica; more complex synthetic polymers such as styrene-maleic anhydride terpolymers and hydrophobically modified ethoxylated urethanes (HEUR); and/or those based on cellulose-ethers and biopolymers (e.g., xanthan gumm, diutan gum, etc.).

The composition may include the wollastonite, the water, the superplasticizer, and the VMA, and may be free, or substantially free, of all other materials. As used herein, the term “substantially free” refers to the composition containing less than 1% by weight of the composition, preferably no more than 0.5% by weight of the composition, and more preferably no more than 0.25% of the composition of the identified component.

The 3D-printable paste was formulated to allow continuous and steady extrusion from the nozzle and shape-holding ability upon deposition. The formulation was developed to provide sufficient yield stress using chemical admixtures to overcome its own weight in the layered printing process. The entire technology is enabled by this formulation that precedes carbonation.

### Example 2—Calcium Silicate Cement as an Alternative to OPC

Deriving strength from the formation of calcite (CaCO₃) and silica gel (SiO₂), the carbonation process uses CO₂ sequestration to harden. During carbonation, calcium carbonate forms which provides crystallization sites for the hydration product C—S—H gel and as a result, this dense matrix improves mechanical performance by reducing the water adsorption and accelerating the strength development of the material.

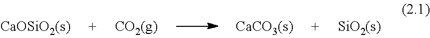

The carbonation of CSC occurs through a two-stage reaction: the first stage occurs at the reactive phase-boundary and is characterized by a fast reaction rate while the second stage is controlled by ionic diffusion through previously formed layers at a significantly slower rate. Carbonation through diffusion occurs in the presence of water (either vapor or liquid) to be adsorbed to initiate the reaction for CSC phases.

Once the diffused atmospheric CO₂ permeates through the solid, the gaseous CO₂ solvates to aqueous solution through a process rate that is proportional to the surface area of the solid. For this reason, non-hydraulic cement carbonation occurs at the surface of the material, favoring stage 1 reaction.

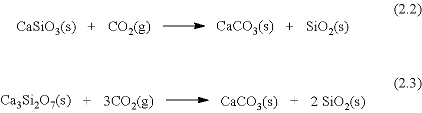

The low-lime CSC is composed of various binder phases, both hydraulic and nonhydraulic. The hydraulic phases are tricalcium silicate (C3S) and the non-hydraulic phases of calcium silicate are rankinite (C3S2), wollastonite (CS) and dicalcium silicate (C2S). The most viable option to reduce the CO₂ footprint of cementitious materials is to reduce the tricalcium silicate and increase the non-hydraulic phases.

The primary reactive components by weight (80% collectively) of CSC are wollastonite/pseudo wollastonite (different polymorphic forms) (CaSiO₃) and rankinite (Ca₃Si₂O₇).

Wollastonite is the stronger component as the carbonation of this specific calcium silicate binder phase results in the direct formation of polymerized Ca-modified silica gel, which optimizes its strength potential, while rankinite forms C—S—H gel before converting into Ca-modified silica gel. The wollastonite phase may be useful as a non-hydraulic CSC binder.

### Material Characterization of Wollastonite

Wollastonite, most used in the production of ceramic materials and paint coatings, originates from limestone found in igneous rocks with the presence of carbon-rich substances and is considered a highly suitable mineral for the sequestration of CO₂. The matrix formed in carbonated wollastonite (calcium carbonate and amorphous silica gel) exhibits similar mechanical properties to the matrix formed through cement hydration (calcium-silicate-hydrate (C—S—H) and calcium hydroxide (CH)). The calcium carbonate (CaCO₃) polymorphs are characteristically tough, resilient, and increase the flexural strength of its material up to 113%. Additionally, the reported elastic modulus of the silica gel and calcium carbonate microscopic phases (41.7 GPa and 67.3 GPa, respectively) are greater than the elastic modulus of C—S—H and CH, which is a critical finding given that C—S—H and CH are commonly referred to as the dominant strength giving phases in hydrated OPC systems.

Wollastonite-based mortar samples can achieve compressive strength as high as 35 MPa when subjected to 50-72 hours of accelerated carbonation. These findings into the mechanical properties of carbonated wollastonite established that the CSC binder possess comparable characteristics to hydraulic cement in terms of relative strength, which has encouraged much research into the space. This encourage the utilization of CSC binders as a partial or complete replacement of conventional cement in concrete mixtures.

Research surrounding this application of wollastonite has focused primarily on its usage as a partial replacement for enhancing cementitious characteristics. As a supplement to cement, wollastonite is used as a microfiber to reduce plastic shrinkage due to moisture loss. By studying the morphology and particle size of the mineral carbonation of wollastonite, it was found that the low-lime binder enhances the pore-creating effect in cement to improve the strength of the material.

Aside from partial substitutes, research is beginning to look at the material characterization of a cast wollastonite-based cement. research continues to explore various aspects related to the mechanical properties of wollastonite, working towards the potential to completely replacing conventional OPC. Even so, the material properties are still being investigated and so current research has not yet been transferred into 3D printing. This is because printing alters the material characteristics of the paste. For example, when it is extruded through the printing tube, rather than laid into a mold, the material self-lubricates so that it can maneuver through the tube without the occurrence of friction. Of course, this layering of free water upon its surface not only impacts the suitability and efficacy of the paste for printing but could also affect the diffusion-based carbonation process.

In this example, the wollastonite sample used was sourced from Vanderbilt Minerals deposit through Seven Springs Farm Supply. Mostly in amorphous form, the theoretical composition is 48.3% calcium oxide (CaO) and 51.7% silicon dioxide (SiO₂). The value for this commercially produced sample is 47.0% CaO and 50.0% SiO₂ which affirms the quality of the powder used.

### Architected Material and Additive Manufacturing

Since the inception of 3D printing concrete more than 20 years ago, additive manufacturing has become a prominent field of exploration for cement manufacturing to enhance its mechanical properties and durability during construction. The application and research of this rapidly developing technology relies on topology optimization, short construction time, and adaptability to a variety of complex structural designs. The requirements for 3D printed cement are different than that for cast cement where the material needs to have adequate printability, which is characterized by sufficient fluidity, extrudability, buildability, and setting time.

Fluidity refers to the cements ability to extrude smoothly from a discharge point and dictates the occurrence of blockage in the equipment. This characteristic is largely impacted by the water content in which a suitable mix for additive manufacturing is one that has high viscosity. A higher water/concrete (w/c) ratio can prevent deformation in the extrusion over the printing process and effectively increase its buildability. On the other hand, if a mixture has a low w/c ratio, admixture supplements can provide slump retention without compromising the fluidity of the extrusion. Such admixtures include Polycarboxylate Ether (PCE) admixture (e.g., available as GLENIUM® admixtures) or polymeric viscosity modifying admixtures (VMA).

When considering the integration of such an admixture, it is important to analyze the potential impacts it could have on the carbonation ability of the wollastonite powder. Little investigation has been done with superplasticizers on calcium silicate-based cement, but literature exists on developing a fundamental understanding on these admixtures with OPC that can be referenced.

A GLENIUM® admixture is a superplasticizer that acts as a water-reducing agent to enhance the fluidity of the cement. By improving the consistency of concrete mixtures and preventing segregation of the material, GLENIUM® admixture is best applicable for situations in which high fluidity and increased durability is needed, as is the case for additive manufacturing.

In general, significant dosage of superplasticizers tend to result in carbonation resistance within ordinary concrete by altering the pore structure, but little impact is seen regarding carbonation depth. It is important to note that these findings are based on hydrated cement. Given the effect of gravity on the subsequent extrusion layers, the print can experience deformation and shape instability under its own weight. To increase its build ability, the cement material needs both shape retention and interlayer support that can be provided by VMA. The VMA enhances pumping of highly fluid concrete and increases the water retention of the mixtures.

The satisfactory impact of VMA on the printability and mechanical performance of cement makes this admixture a promising option. Considering its implications on carbonation, hydrated samples including VMA exhibited higher calcium carbonate content compared to the controlled samples. Past studies have also seen how VMA content correlates with increased shape stability and reduced horizontal deformation between filaments where the threshold for the most improved stability occurs with VMA dosage between 0.14% to 0.24%.

The time during which the cement is stirred with the water and admixtures, referred to as the setting time, can influence the printing performance as well. In addition to the material composition of the mixed design, the specifics of the printing parameters, related to extrudability, strongly influence the final properties. These include the nozzle size, the nozzle head from the printing plate, extrusion speed, and interlayer printing time. The continuity and general surface quality of the extruded paste is related to the aggregate particle size in relation to the diameter of the extrusion nozzle. Likewise, the speed of the nozzle directly correlates with the hardening speed of the printed concrete.

Coupled with the speed, the printing head impacts the settlement of the extruded strips, which correlates to the tensile bonding strength between layers. The interlayer bonding is critical to the structural mechanical properties of the non-hydraulic cement print. However, a concern of 3D printing is the occurrence of evaporation during printing which can impact the interlayer bonding of the printed filament joining points and impede the diffusion of CO2 during the carbonization process.

Additive manufacturing is conducted in an environment exposed to external factors. The low water to cement ratio that is typically characteristic of 3D printing cement increases the likelihood of cracking from autogenous shrinkage due to water loss. To avoid such occurrences, dimensional changes in mix designs should be coupled with greater care in the curing process. In additive manufacturing, more creative algorithmic methods can compensate for material properties to enable more robust designs which depends on producing repeatable and consistent properties to analyze the printability of the material mixture.

The various testing here was carried out in three definitive phases. The first step was to create a paste mixture suitable for 3D printing.

Given this understanding on the impact w/c ratio and admixtures have on augmenting the printability of traditional cement paste, various design matrices were considered to observe the relative change in consistency, texture, and viscosity to determine a suitable printing mix for wollastonite-based paste. With the determined mixed, or ink, design, two sets of samples were prepared. The first consisted of both print and cast linear filaments to compare the carbonation performance of 3D printed wollastonite-based cement to what is seen in the literature for the cast counterpart. The degree of carbonation was quantified using scanning electron microscope (SEM) analysis, thermogravimetric analysis (TGA), and X-ray diffraction analysis (XRDA). To explore the depth of carbonation and the flexural strength of cement produced using additive manufacturing, the second set of samples was composed of three prismatic designs: cast, lamellar (100% infill) print, and cellular (60% infill) print.

In certain embodiments of the disclosed systems and methods, the cellular print may be from 10%-90% infill. In certain embodiments of the disclosed systems and methods, the cellular print may be from 20%-80% infill. In certain embodiments of the disclosed systems and methods, the cellular print may be from 30%-70% infill. In certain embodiments of the disclosed systems and methods, the cellular print may be from 40%-60% infill. All ranges are inclusive of the endpoints.

The prismatic samples were tested using Three-Point-Bending test and Phenolphthalein pH indicator solution. Both sample sets were placed into a carbonation chamber for approximately three days. A set of cellular OPC cement samples was also printed to reference in the Three-Point-Bending load analysis.

### Sample Preparation

### Experimental Determinism of the Mixed Design

It has been previously been found that the ideal w/c ratio for cast wollastonite is 0.4 if carbonated at around 30° C., 10% CO₂, and 90% RH. The reduction of the w/c value results in an increased viscosity of the paste, confirming that the same or slightly lower ratio to the cast paste (around 0.35-0.4) is an adequate value for the w/c ratio for the printed wollastonite binder. In fabricating the mixed design, the initial focus was on printability through the compositional ratios (w/c, Glenium, and VMA) and then evaluating the extrudability by the printing parameters.

TABLE 1
Selected iterations of ink design
with varying w/c, admixture content

| | | Glenium | VMA Dosage | Overlap |
|---|---|---|---|---|
| Trial | W/C | Dosage (%) | (%) | (%) |
| 2 | 0.35 | 0 | 0 | 60 |
| 4 | 0.35 | 0.15 | 0 | 5 |
| 5 | 0.35 | 0.15 | 0.05 | 10 |
| 9 | 0.45 | 0.25 | 0.08 | |
| Final | 0.4 | 0.25 | 0.14 | |

### Fluidity and Buildability

Through the experimentation of the mixed design, the qualities of the GLENIUM® admixtures and VMA have in cement mixtures are analogous to when used in wollastonite-based paste. Trials 4 and 5 (T4 and T5, see Table 1) indicated that the ink design needed to have at least a w/c ratio of 0.4 for it to be viscous enough to put into the syringe for printing. Even with an increased amount of GLENIUM® admixture, the trials with a higher w/c ratio had a more desirable fluidity and experienced less resistance when transferring the material into the syringe.

To understand potential improvements in the ink design's buildability, two prints were made as a continuous filament in a square wave-like pattern: the first with a VMA content of 8% and the other of 14%. The second filament was printed with wider spacing to reduce the amount of material used during the trial. Regardless, the measured deformation upon printing of the filament with 14% VMA is lower than the second print with a lower VMA content, supporting past findings on VMA's influence with improving shape stability in additive manufacturing.

After including the VMA content to increase the buildability, it was determined that the w/c ratio would still need to be reduced to increase the print's shape stability.

### Geometric Imperfection and Tuning the Processing Parameters Elements

Throughout the ink design trials, three issues related to the extrudability that led to further improvements on the printing method and set parameters.

### Clogging Related to Nozzle Size

When testing T9 with the printer, the extrusion quickly began to segregate into water droplets, suggesting that the poor extrudability of the printing parameters occurred because the nozzle size was too small. To avoid the pressure build-up in the nozzle extrusion and the segregation in the printed specimens, a larger 2.5 mm diameter nozzle was used. To account for the change in nozzle size, modifications were made in the 3D printer configuration (specifically, the Ultimaker gcode) to alter the extrusion speed, extrusion multiplier, and the primary layer height.

### Clumping and Collapsing Related to Overlap and Extrusion Speed

Additionally, discontinuity in the extrusion began to form, resulting in visible clumping of the material while it was printing. There was also observed disconnect in the cellular samples that appeared to be attributed to the insufficient overlap value, or the distance allowed between the infill and outline, coupled with the high extrusion speed of the paste that prevented the deposited paste from attaching to the previous layers. For this reason, when the extrusion speed was slowed to 130, the layering significantly improved. Additionally, correcting the spacing was done so that the cellular infill did not overlap the perimeter to avoid the creation of an uneven surface and eventual segregation. At the same time, the spacing could not be too large which would form an aperture between the cellular infill and the perimeter, causing the outline to pinch in and collapse. With this rationale, an overlap of 10% was the most successful in creating consistent layering in the print design. It was also noted that the slow extrusion speed allowed the previous layers to partially dry before the subsequent layers, improving the buildability when coupled with the increased VMA content.

### 3D Printing Design and Mixing Procedure

The schematics of the print designs were drawn in Simplify3D, a platform to model 3D printed designs, and printed using the Ultimaker2+® (UM2+) 3D printer. Before each print, the UM2+ was calibrated so that the print head was set to 1 mm from the printing plate. The raw materials were combined and stirred twice at 400 rpm for 90 seconds in a commercial vacuum mixer. Once it was mixed, the paste was transported into the syringe with careful consideration in removing any apparent air bubbles that could have impacted the extrusion. The syringe was then attached to the holder at the side of the printer and connected to the tube with the other end attached to the extrusion nozzle. Time is allowed for the machine to purge the material from the syringe to the nozzle tip. With the setup ready to extrude the paste, the Simplify3D commands the UM2+ printer to commence the print.

### Design of Printing Toolpath and the Materials Architecture

For the carbonation analysis, the thickness and spacing density are important whereas the geometries of the filament and degrees of cellularity of the material influences the strength of the 3D-printed objects. Polymeric lattices optimize the ductility of 3D printed filaments when the orientation is aligned with the expected tensile stresses. This example on lattice structural design in relation to the cellularity of the concrete and with consideration to its impact on flexural strength.

To understand the trade off between ductility and augmented carbonation, a simplified lattice infill was utilized. The rectangular lattice structure chosen for the printed samples demonstrates the best ensures the highest flexural properties when compared to alternative lattice-shaped structure with square or triangular topology. The exact dimensions of the prisms that were printed were limited by the amount of available material for printing and casting.

The lamellar sample printed so each layer alternates between 0- and 90-degree offsets along the x and y directional planes. This was done to ensure that any recorded differences in the strength or carbonation between the samples is most likely due to the difference in cellularity rather than the printed orientation. So that the theoretical density of the sample is half of the lamellar printed density, the cellular samples had a 60% infill.

### 3D Printing Samples

Once the ink design and printing parameters were finalized, the filament samples were printed while the cast samples were prepared. Concurrently, the cellular and lamellar samples were printed and casted. The cast samples for both sample sets were prepared by 3D printing a plastic outline to hold the mixture using the same ink design. The limiting factor in the number of layers printed appeared to be that the syringe could no longer discharge the paste without too much pressure building up in the apparatus.

The process of purging the material wastes the material and could be building up precursory pressure in the system. This could be improved upon by minimizing a distance from the syringe (or the material source and pump) to the nozzle. A possibility includes suspending the syringe directly above the nozzle to improve the material use efficiency of the setup.

Regardless, given these printing constraints, a maximum volume of the material could be extruded per session. Since the size of the printed sample decreased as the percent infill increased, with an equal width and length value (24 mm and 72 mm, respectively), the lamellar size could be printed at a max height of around 6 mm while the cellular could be printed up to 10 mm without segregation and clogging.

### Carbonation Setup and Inputted Parameters

The fully-enclosable carbonation chamber operates by maintaining the set internal temperature and relative humidity conditions for a certain concentration of CO₂. The incubator used was installed at a temperature setpoint of 20° C. within an allowed temperature range of 10-55° C. and a CO₂ concentration range of 0-20%. The incubator's CO₂ sensors are calibrated for 37° C. and a 95% Relative Humidity (RH) is reached. For this example, the controlled conditions of the carbonation chamber were set to the calibrated values of 95% RH, 37° C., and 20% CO₂.

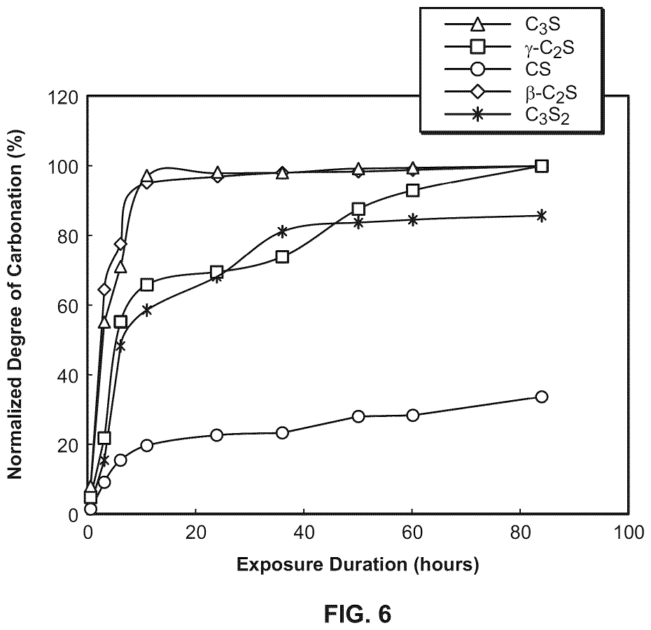

Under analogous conditions, previous researchers have found that a wollastonite cast sample carbonated for a duration of 50-72 hours leads to its maximum degree of carbonation. See FIG. 6.

The gas used is an Airgas Part food grade carbon dioxide in a Size 40 High Pressure Steel Cylinder, CGA-320. To connect the CO₂ supply, the two-stage pressure regulator was installed at the cylinder outlet with the high-pressure gauge at the tank set to between 500 and 1000 psi and the low-pressure gauge at the incubator inlet maintained at 15 psi. Once the calibration parameters were set, two hours were allowed for the chamber's condition to stabilize before proceeding. It was during this time that the samples were printed. Once in the chamber, the casts and prints were assumed to be uniformly carbonated over the chosen time frame of 3 days.

### Arresting Carbonation Technique

Various pre-drying techniques to minimize further carbonation in the presence of water include oven or vacuum oven drying to remove unbounded water. But these practices risk damaging the microstructure and altering the pore structure of the material. Here, plastic film was used to prevent contact with atmospheric CO₂ and used to halt carbonation when removing the samples from the chamber and preparing them for testing.

### Observations of Carbonated Samples

Immediately after a sample was removed from the carbonation chamber and measurements were made, it was wrapped in a plastic film until testing. Along the way, the following observations were made for each sample set.

### Filament Samples

There is visible deformation in the deposition of the printed filaments where the experimental width is greater than the theoretical value set in the printing parameters. When looking at the cross-sectional area of the filament taken with microscopic imaging, the horizontal deformation is apparent, flattening the arch of what was expected to be a circular extrusion. This implies that more admixtures could be supplemented for improved shape stability, although some deformation is expected under the self-weight of subsequent layering. Additionally, the slight reduction in the height is negligible for the purpose of this study since the new height remains within the 1- and 2-mm height range for the cast sample by Ashaf et al., that the findings will be compared to. As the diffusion based reaction is substantially affected by the sample dimensions, it is important that these heights are comparable to make reasonable inferences from the test results in relation to the literature.

Since the cast filament was confined by the plastic outline, the theoretical dimensions were consistent with the experimental. Yet, the sample was extremely difficult to remove without crumbling which leads me to believe that it did not harden entirely whereas Ashraf et al. did not record similar issues. This could be because Ashraf et. al scraped the cast sample onto a plate rather than placing into a mold. Henceforth, the sample carbonated from all directions except the bottom surface while here, the CO₂ only penetrated through the top exposed surface.

### Prismatic Samples

There was some observed cracking in the lamellar samples upon carbonation which could be attributed to the relative humidity or the amount of free water available in the chamber. Since the relative humidity was held constant at the set 95% value, it is suspected that the cracking could be due to a layer of water on the printing paste from lubrication upon extrusion. Due to deformation under loading of self-weight, the difference in the dimensional values between the base and top of the sample was greater in the lamellar samples than the cellular since a greater infill percentage increased the density of the subsequent layers. The specimens were sanded down to create flat surfaces along each face of the prism and average values were used for the inputted parameters when calculating the elastic modulus. Both the large and small cellular samples exhibit bleeding within the internal lattice structure which can be from a low shape stability or also gradual deformation under self-weight as the samples were carbonating. There is more observed bleeding in the small cellular sample compared to the large cellular sample, which are differentiated by their respective heights. Like what was observed in the cast filaments, the cast prismatic samples were difficult to remove from their outline and appeared weaker than what would be expected.

The TGA and SEM were run on samples from the cast filament. The fragile cast filaments were not solidified, making it difficult to obtain a cross-sectional sample for the SEM analysis.

In preparation for the TGA analysis, the carbonated samples were ground into powdered form. Approximately 30 mg were placed in the TGA instrument and purged with nitrogen gas. The analysis was programmed to maintain isothermal conditions of 23° C. for the first 10 min and then heated to 1000° C. at a constant rate of 10° C./min. Particular focus was placed on the temperature range of 400-900° C. since weight loss of the sample here can be attributed to the decomposition of calcium carbonate (CaCO₃) due to the sequestration of CO₂. Referring to the stoichiometric equation for the decomposition of the carbonated product (Eq 4.1), the amount of calcium carbonate and the degree of carbonation was calculated from the weight loss observed (Eq 4.2).

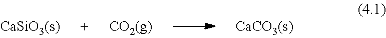

$$Degree of carbonation ( α ) = \frac{Amount of {CaCO}_{3} ( wt \% ) at time t}{Maximum amount of {CaCO}_{3} ( w t \% ) formed} \qquad ( 4.2 )$$

The calculation for the percent weight loss of CaO₃ involved the utilization of the first derivative (DTG) and second derivative (DTG) curves that were automatically calculated by the TGA instrument, an approach proposed for greater accuracy in determining the degree of carbonation. Such techniques are well understood in the art. The inflection point in the TGA, the moment also represented by the minimum point of the DTG curve, signals to the decomposition of CaO₃. From the percent weight difference of this range, the amount of CaO₃ (wt/o) was calculated (Eq. 4.3) using the respective molecular weight of CaO₃ and CO₂. The findings from the three filament samples (F1, F2, and F3) tested along with a casted sample are summarized in Table 2.

$${CaCO}_{3} ( g / g ) = \frac{C a C {O}_{3} molar weight}{C {O}_{2} molar weight} \times \frac{δ {M}_{b e t ween peaks} ( g )}{{M}_{s a m p l e} ( g )} \qquad ( 4.3 )$$

Table 2: measured percent weight loss, calcium carbonate deposition, and calculated degree of carbonation for each filament sample compared to the approximate carbonation value based on literature

| | TGA percent | CaCO3 content | Degree of Carbonation, |
|---|---|---|---|
| Sample | weight loss (%) | decomposed (%) | filaments (%) |
| F1 | 5.3 | 12.05 | 28.03 |
| F2 | 6.8 | 15.56 | 35.37 |
| F3 | 6.2 | 14.07 | 32.21 |
| Average F | | | 31.87 |
| C | 1.7 | 3.8 | 8.85 |

When comparing the TGA results of the print and cast filament, the print filaments show a significantly higher degree of carbonation compared to cast of the same thickness. Given the approximate degree of carbonation for cast in literature (see Table 2), one should expect the prepared cast samples to have comparable results, but it is actually the printed filaments that have comparable values to the literature. As the carbonation process is directly linked to the hardening of wollastonite-based cement, this suggests an insufficient amount of carbonation occurred for the prepared cast sample and a better carbonation in the print filament. This difference is remarkable which could be due to a higher porosity in the filament or greater amount of free water on the surface that could augment the diffusion based reaction to occur.

The difference between the approximate cast and the average print degree of carbonation is statistically insignificant, suggesting that the carbonation degree of the filament is comparable to the data in the literature.

### Three-Point Bending Test

The flexural strength is used to characterize the mechanical properties of the 3D printed wollastonite cement for each experimental design. Each printed sample was subjected to a three-point bending test to compare the flexural strength and overall toughness as a characterization of their mechanical behavior.

The three-point bending test was set to a speed of 0.01 mm/min and, following ASTM standards for cement and concrete, was programmed to set the span of each observed sample to three times this measured height. The inputted width values of each sample were calculated as the average between the top and base measurements.

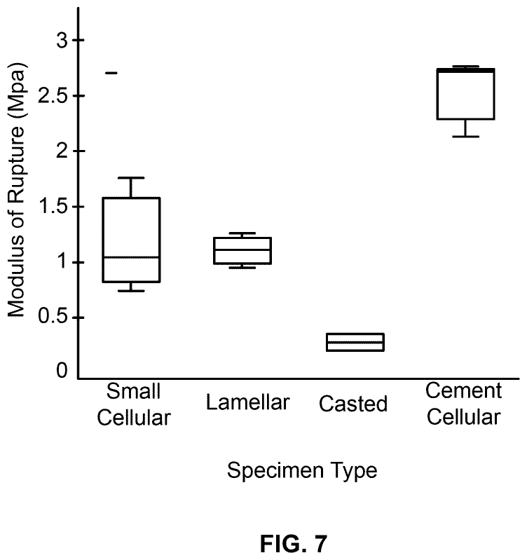

The flexural strength of the samples was calculated from the load-displacement measured. As the sample percent infill decreases across the prismatic specimen types, the variability and mean value for the modulus of rupture decreases. As seen in FIG. 7, the modulus of rupture for various specimen types is shown. The variance for the various types was found to be 0.2697 (small cellular), 0.0251 (lamellar), 0.0123 (cast), and 0.1204 (cement cellular).

While the cellular sample as a marginally lower mean value than the lamellar sample, the cellular has a greater variance in the measured flexural strengths of the samples. Although these results are inconclusive in terms of which specimen type exhibits greater strength, inferences can be made as to why this occurred that can be corrected with better development into material architecture. The only difference between the two cellular samples is in their infill, so it is expected that their modulus of rupture would be different. It was earlier noted that the small cellular samples exhibited higher occurrences of inconsistent bleeding into the lattice infill where some samples recorded more instances than others. To further explore the potential impact the bleeding had on the cellularity, and effectively its influence on the observed flexural strength results, the experimental infill percentage was calculated (see Table 3).

Table 3: comparison between theoretical and experimental percent infills of each sample type examined in a modulus of rupture plot.

| | OPC Cement | Cellular | Lamellar |
|---|---|---|---|
| Theoretical infill (%) | 60 | 60 | 100 |
| Experimental infill (%) | 67.32 | 89.95 | 99.83 |

This was quantified by the relative densities of the printed samples to the correlating cast samples of similar dimensions. For the cast flexural strength, it was initially surprising to see the low value, especially when wollastonite cast has been reported to have a flexural strength within the range of 5.7-8.2 MPa. It was then speculated whether this sample was thoroughly carbonated. Possible explanation includes the way in which the sample was cast compared to past research methodologies coupled with the length of carbonation. For example, Ashraf et al. prepared their cast samples by creating a paste of small thickness [7]. However, in this experiment, the cast sample is approximately 6 mm, almost 5-10 times the height of the referenced study. For this reason, it is possible that the sample would have required significantly more time for the diffusion reaction to reach the increased depth and achieve the same level of carbonation.

When placing the wollastonite cellular samples in context to the cellular cement samples also tested, their flexural strength is approximately half of the value measured for the cement counterparts. More importantly, the mean value is consistent with the literature that reports a flexural strength of 3 MPa for cast cement, which is approximately 10% of the cast compressive strength. It is interesting that with the same architected design, the cellular OPC cement correlates with the OPC cast values while there is more deviation in the wollastonite cellular and reported cast data. It is important to note that given the difference in their material composition, there was less of a limiting factor in printing cement than experienced with the wollastonite printing ink design. For this reason, each cellular cement sample was printed to completion and so the proportionality of their dimensions differs to that of the wollastonite. This could account for some inconsistencies in the respective relationship between cellular and cast flexural strengths. Yet, extending upon the discussion on theoretical versus experimental infill, the experimental infill of the OPC cement samples was smaller than the wollastonite because the cement samples had little to no observed bleeding. This again proposes a consideration to the impact reduced bleeding may have had on the results for the wollastonite cellular.

### Phenolphthalein Solution Test

Phenolphthalein indicator solution was applied to the cross section of a cellular and lamellar sample to investigate how the exposed surface area impacted how far the carbonation process could reach into the internal matrix of each sample. The solution is a phenolphthalein 1% ethanol solution with 1 g phenolphthalein and 90 ml 95.0 V/V % ethanol diluted in water. Uncarbonated wollastonite has a pH of 9.9 to 10 once the gaseous CO₂ diffuses through the material's surface during carbonation, the CO₂ hydrates to H₂CO₃ which then ionizes to H⁺, HCO₃⁻, CO₃²⁻, instantaneously dropping the pH by approximately 3 units. For this reason, when the phenolphthalein indicator solution is applied onto the cementitious material, we would expect any regions that are carbonated to remain white and those that are uncarbonated to turn pink. A cross section of each sample was cut, cleaned, sprayed with the with phenolphthalein pH indicator, and then placed into a microscope to identify areas of carbonation.

Despite the difference in their architectural design, the cellular and lamellar samples were thoroughly carbonated as indicated by the white surface of both after the application of the phenolphthalein pH solution. At a small scale, the depth of carbonation is equivalent for a cellular and lamellar sample despite their relative difference of percent infill. Since it is known that carbonation occurs through the surface of the material, it can be expected that a greater exposed surface area would allow the carbonation to reach deeper layers. But given that the lamellar is already relatively short, it is understood that the amount of exposed surface area was sufficient for the carbonation process to reach the bottom of the sample.

However, it is expected that there is a maximum height for which the ratio of exposed surface area to height is able to impact the penetration depth of carbonation in a sample. This hypothesized ratio was unobtainable in these experiments due to the limitations in which the samples were printed.

Comparatively, one can see how the partial cast sample turned pink upon contact with the pH indicator solution, with darker coloring closer to the bottom. The appearance of the cast being largely uncarbonated supports earlier findings in the weak flexural strength measured for the cast sample. There is some slight white at the top of the partial cast sample, marking what appears to be the carbonation threshold. Since 6 mm is approximately the halfway point, this would mean that the carbonation only reached the midpoint of the sample. Alternatively, it could be that after being cut and transported, this region was exposed to the atmospheric CO₂ and began to carbonate. The appearance of white along the right edge of the cast sample supports the latter. Regardless of whether the carbonation diffused to this depth or if the top layer only began carbonating once in contact with the atmosphere, these findings indicate that this was the maximum depth reached during the carbonation of the cast sample. While carbonation reached 10 mm in the cellular sample, it only reached a depth of approximately 4 mm in the cast sample, leaving 6 mm still uncarbonated.

Based on the example analysis both on the filaments and the prismatic materials, the following conclusions can be inferred:

1. For the TGA results, they were run on two filaments: one printed and one cast, but both with the same exact theoretical dimensions. Even with the same thickness, the print largely outperformed the cast counterpart in terms of degree of carbonation (33% vs 8%). But, once comparing the respective carbonation degrees to cast sample prepared by Ahsraf et al. of the same height as an indication for the literature, print sample performed just as well whereas the cast filament sample. The results of the TGA, SEM, and XRD for the printed filament are consistent in terms of the printed samples carbonation degree. The findings suggest that the carbonation performance of printed wollastonite is comparable to its cast counterpart, indicating the potential in augmenting the process through the optimization of other factors not explored in this paper.

2. The difference in the morphological features of the print and cast samples is apparent as the printed sample is characterized by a high density of calcite grains and the cast by large amounts of unreacted wollastonite. The cast only reached the phase-boundary controlled reaction (stage 1) whereas the print reached the diffusion-based reaction (stage 2) which is evident by the difference in their degree and depth of carbonation from the experiments carried out. Most significantly, the insufficient carbonation of the cast sample supports our hypothesis on the reliance of carbonation on surface area through a lower carbonation depth in cellular and solid lamellar 3D-printed materials with inherent layered porosity.

3. The findings suggest that the cellular sample exhibited a higher carbonation depth with a greater exposed surface area than the cast sample. For smaller heights, the lamellar sample was also thoroughly carbonated based on phenolphthalein results, suggesting that there may be a height threshold beyond which the cellular would outperform the lamellar as it did the cast. Even more, the inherent layered porosity from the 3D-printing process promotes the carbonation within the volume as interconnected carbonation network. Henceforth, the reason for higher carbonation is in the porosity of the SD printed samples.

4. The mean flexural strength of the cellular and solid lamellar samples, approximately 1.2 MPa, are significantly lower than the value for cast wollastonite provided in the literature at a mean value of 6.95 MPa. Yet, the casted samples prepared experimentally had a very low value. Confounded with inferences from the other tests ran during this experiment, it can be concluded the cast samples prepared here were not sufficiently carbonated, possibly because of their insufficient surface area exposure from the outline mold. Overall, the findings place printed wollastonite as a comparable method to casting it.

As a competitive alternative to its cast counterpart for carbonation, printed wollastonite also leverages the environmental and efficiency incentives of additive manufacturing. When coupled with the benefits of 3D printing, with the waste reduction and other environmental benefits of 3D printing, my findings demonstrate how additive manufacturing with wollastonatie will be more sustainable than just casting.

What is claimed:

1. A print head, comprising:
a print head body defining a central lumen extending from a first end to a second end of the print head body along a central axis, the first end defining a first inlet for receiving a 3D printable material, the second end defining a first outlet for distributing the 3D printable material;
a plurality of gas outlet nozzles, each gas outlet nozzle distributed around the first outlet and configured to direct a gas away from the second end of the print head body and reach any output 3D printable material, each gas outlet nozzle being operably coupled to an internal distribution cavity defined by the print head body, the internal distribution cavity being disposed around the central lumen, the print head body further defining a gas inlet coupled to the internal distribution cavity, the gas inlet configured to be operably coupled to a source of a gas.

2. The print head according to claim 1, wherein the plurality of gas outlet nozzles includes 3-5 gas outlet nozzles.

3. The print head according to claim 2, wherein each gas outlet nozzle is spaced an equal distance from an adjacent gas outlet nozzle.

4. The print head according to claim 1, wherein the 3D printable material is a cement.

5. The print head according to claim 4, wherein the cement is a wollastonite-based cement.

6. The print head according to claim 1, wherein the gas is carbon dioxide.

7. The print head according to claim 1, wherein each gas outlet nozzle has a central axis that is substantially parallel to the central axis of the print head body.

8. The print head according to claim 1, wherein at least one gas outlet nozzle of the plurality of gas outlet nozzles has a central axis that is angled relative to the central axis of the print head body.

9. A system, comprising:
a print head according to claim 1;
a gas source of a gas; and
a tube coupling the gas source to the gas inlet of the print head.

10. The system according to claim 9, further comprising a valve between the gas source and the print head.

11. The system according to claim 9, further comprising a printing plate disposed at a distance from the second end of the print head body, configured to receive material output from the print head.

12. The system according to claim 11, further comprising a housing or cover around at least the print head and the printing plate, configured to prevent at least some gas output by a gas outlet nozzle of the print head from escaping a volume of space within the housing or cover.

13. A method for in-situ carbonation, comprising forming a deposited 3D printed material by depositing a 3D printable material while carbon dioxide gas is diffused onto the deposited 3D printed material.

14. A method for layer-3D printing with induced interfaces, comprising:
depositing a 3D printable material with a first porosity in the presence of carbon dioxide;
depositing the 3D printable material with a second porosity in the presence of carbon dioxide, the second porosity being greater than the first porosity; and
allowing the carbon dioxide to diffuse into the 3D printable material, wherein the 3D printable material with the second porosity will have an increased degree of carbonation.

15. A method for designing 3D objects, comprising:
receiving information representative of a 3D object;
forming a plurality of slices of the 3D object in a cellular fashion, each slice determined based on one or more parameters, the plurality of slices determined to enhance carbonation of at least a portion of the 3D object; and
outputting a path for a 3D printer based on the plurality of slices in a predetermined format.

16. A composition, comprising:
wollastonite;
water, at least about 40% by weight of the composition;
a superplasticizer, at up to about 0.25% % by weight of the composition; and
a viscosity-modifying admixture (VMA), at up to about 0.14% by weight of the composition.

17. The composition according to claim 16, wherein the superplasticizer is a polycarbonate ether (PCE) admixture.
